(19) United States
(12) Patent Application Publication
(10) Pub. No.: US 2026/0147986 A1
(43) Pub. Date: May 28, 2026

(54) LANGUAGE MODEL ENSEMBLE FOR AUTOMATICALLY PREPARING ELECTRONIC FORMS

(71) Applicant: INTUIT INC., Mountain View, CA (US)

(72) Inventors: Isham RAJGARIAH, Bangalore (IN); Parmanand MOURYA, Bengaluru (IN); Yerubandi Ram KARTEEK, Andhra Pradesh (IN); Pradeep Kurunimakki LAXMINARAYANA, Karnataka (IN); Sandeep MEWARA, Bengaluru (IN); Sanjay GUPTA, Karnataka (IN); Sarat Dev SATHEESAN, Karnataka (IN); Sanjay KUMAR, Karnataka (IN)

(73) Assignee: INTUIT INC., Mountain View, CA (US)

(21) Appl. No.: 18/960,902

(22) Filed: Nov. 26, 2024

(51) Int. Cl. G06F 40/174; G06F 16/93

(52) U.S. Cl. CPC G06F 40/174; G06F 16/93

(57) ABSTRACT

A method for preparing a completed electronic form from an initial electronic form that is initially unknown and using form data that initially is unavailable. A first language model is executed on a first prompt to generate a number of questions related to a number of electronic forms. A number of answers to the questions are received. The initial electronic form is, using the answers, identified from among the electronic forms. A structured language data structure storing data including values of fields of the initial electronic form is generated from the answers. A second language model is executed on a second prompt to generate a mapping schema that defines a mapping of the values in the structured language data structure to the fields of the initial electronic form. The completed electronic form is generated by applying, according to the mapping schema, the values to the initial electronic form.

### BACKGROUND

Electronic forms are useful tools for exchanging information and for providing input to various computer-implemented automated functions. However, preparing the electronic forms manually may be a time-consuming and undesirable process. The process is made more onerous when the initial electronic form that should be used is unknown. The process is made more onerous still when the data for preparing the electronic form initially is unknown.

Thus, a technical challenge is presented. The technical challenge is programming a computer to select, automatically, a correct electronic form to use when the electronic form initially is not known and then to prepare, automatically, the correct electronic form with the data when the data initially is unknown. An additional technical challenge is that often follow-up questions should be answered before preparing the electronic form, but it is not known ahead of time (i.e., a-priori) which follow-up questions to ask. Because the electronic form initially is not known, and the data initially is not known, it is impractical or impossible to apply a straightforward algorithm to select, automatically, the correct form and prepare, automatically, the correct form.

### SUMMARY

One or more embodiments provide for a method for preparing a completed electronic form from an initial electronic form that is initially unknown and using form data that initially is unavailable. The method includes executing a first language model on a first prompt to generate a number of questions related to a number of electronic forms. The method also includes receiving a number of answers to the questions. The method also includes identifying, using the answers, the initial electronic form from among the electronic forms. The method also includes generating, from the answers, a structured language data structure storing data including values of fields of the initial electronic form. The method also includes executing a second language model on a second prompt to generate a mapping schema that defines a mapping of the values in the structured language data structure to the fields of the initial electronic form. The method also includes generating the completed electronic form by applying, according to the mapping schema, the values to the initial electronic form.

One or more embodiments also provide for a system. The system includes a computer processor and a data repository in communication with the computer processor. The data repository stores a processor command to prepare, automatically, a completed electronic form for a user having a user identification. The data repository stores an initial electronic form selected from among a number of electronic forms. The data repository also stores a number of questions related to the electronic forms. The data repository also stores a number of answers corresponding to the questions. The data repository also stores a first prompt. The first prompt commands a first language model to generate the questions. The data repository also stores a structured language data structure. The data repository also stores a context. The data repository also stores a mapping schema that defines a mapping of values in the structured language data structure to fields of the initial electronic form. The data repository also stores a second prompt for a second language model. The second prompt includes a first section and a second section. The first section commands the second language model to reference the context including data formatting rules and data mapping rules. The second section commands the second language model to generate the mapping schema. The data repository also stores the completed electronic form. The completed electronic form is based on the initial electronic form. The system also includes a server controller which, when executed by the computer processor, performs a computer-implemented method. The computer-implemented method includes receiving the processor command. The initial electronic form is initially unknown and form data for the completed electronic form initially is unavailable. The computer-implemented method includes generating, using the user identification, the first prompt. The computer-implemented method also includes executing the first language model on the first prompt to generate the questions. The computer-implemented method also includes transmitting the questions to the user and receiving the answers from the user. The computer-implemented method also includes identifying, using the answers, the initial electronic form from among the electronic forms. The computer-implemented method also includes generating, from the answers, the structured language data structure. The computer-implemented method also includes generating the second prompt. The computer-implemented method also includes executing the second language model on the second prompt to generate the mapping schema. The computer-implemented method also includes generating the completed electronic form by applying, according to the mapping schema, the values to the initial electronic form.

One or more embodiments also provide for another method. The method includes receiving a processor command to prepare, automatically, a completed electronic form for a user having a user identification. The completed electronic form is based on an initial electronic form selected from a number of electronic forms. The initial electronic form initially is unknown. Form data for the completed electronic form initially is unavailable. The method also includes generating, using the user identification, a first prompt for a first language model. The first prompt commands the first language model to generate a number of questions related to the electronic forms. The method also includes executing the first language model on the first prompt to generate the questions. The method also includes transmitting the questions to the user and receiving, from the users, a number of answers corresponding to the questions. The method also includes identifying, using the answers, the initial electronic form from among the electronic forms. The method also includes generating, from the answers, a structured language data structure storing data including values of fields of the initial electronic form. The method also includes generating a second prompt for a second language model. The second prompt includes a first section and a second section. The first section commands the second language model to reference a context including data formatting rules and data mapping rules. The second section commands the second language model to generate a mapping schema that defines a mapping of the values in the structured language data structure to the fields of the initial electronic form. The method also includes executing the second language model on the second prompt to generate the mapping schema. The method also includes generating the completed electronic form by applying, according to the mapping schema, the values to the initial electronic form.

Other aspects of one or more embodiments will be apparent from the following description and the appended claims.

### BRIEF DESCRIPTION OF DRAWINGS

FIG. 1 shows a computing system for an improved language model ensemble for automatically preparing electronic forms, in accordance with one or more embodiments.

FIG. 2 shows a flowchart of a method for an improved language model ensemble for automatically preparing electronic forms, in accordance with one or more embodiments.

FIG. 3A shows an architecture of a computing system for an improved language model ensemble for automatically preparing electronic forms, in accordance with one or more embodiments.

FIG. 3B shows a data flow for an improved language model ensemble for automatically preparing electronic forms, in accordance with one or more embodiments.

FIG. 4A, FIG. 4B, and FIG. 4C show an example of a first prompt for a first language model to generate a number of questions related to a number of electronic forms, in accordance with one or more embodiments.

FIG. 4D, FIG. 4E, and FIG. 4F show an example of a second prompt for a second language model to generate a mapping schema that defines a mapping of the values in the structured language data structure to the fields of the initial electronic form, in accordance with one or more embodiments.

FIG. 5A and FIG. 5B show an example of a computing system and a network environment, in accordance with one or more embodiments.

Like elements in the various figures are denoted by like reference numerals for consistency.

### DETAILED DESCRIPTION

One or more embodiments are directed to systems and methods for programming a computer to select, automatically, a correct electronic form to use when the electronic form initially is not known and then to prepare, automatically, the correct electronic form with the data when the data initially is unknown. One or more embodiments also provide for procedures for generating appropriate follow-up questions that should be answered before preparing the electronic form. Thus, one or more embodiments are directed to addressing the technical problems described above (i.e., the problem of how to program a computer to automatically generate a filled-in electronic form when the nature of the form and the data used to fill the form initially are unknown).

Briefly, one or more embodiments use an ensemble of language models to generate questions relating to an end user or end purpose for which the electronic forms will be used. Answers to the questions are then generated or are received. In some cases, the answers may prompt the language model to generate additional questions for which answers are generated or received. The process may proceed iteratively until the server controller determines that no additional questions remain.

Once the questions and answers are generated and received, a server controller may select the correct electronic forms to be filled. However, because the answers generally are in a data format which is incompatible with the correct electronic forms, one or more embodiments may employ a second language model. The second language model converts the answers into a data schema suitable for use for filling the electronic form. The server controller then may use the data schema to fill the electronic form automatically. The filled-in forms may then be presented to a user or to an automated process as completed documents for further processing, or for validation and then further processing.

One or more embodiments described above are agnostic to the type of electronic forms being prepared because the technical solution described above may be applied in a variety of different contexts for electronic forms expressed in a variety of different data schemas. Nevertheless, a specific example of one or more embodiments is presented to highlight operation of one or more embodiments.

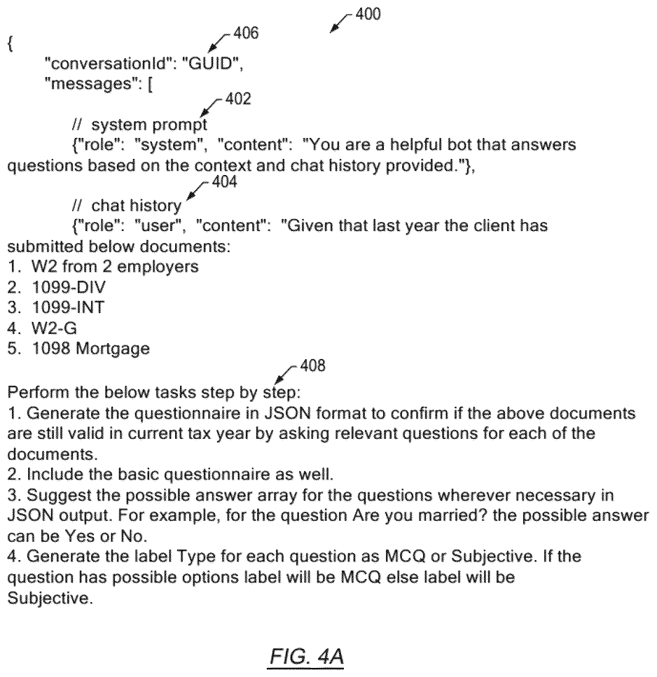

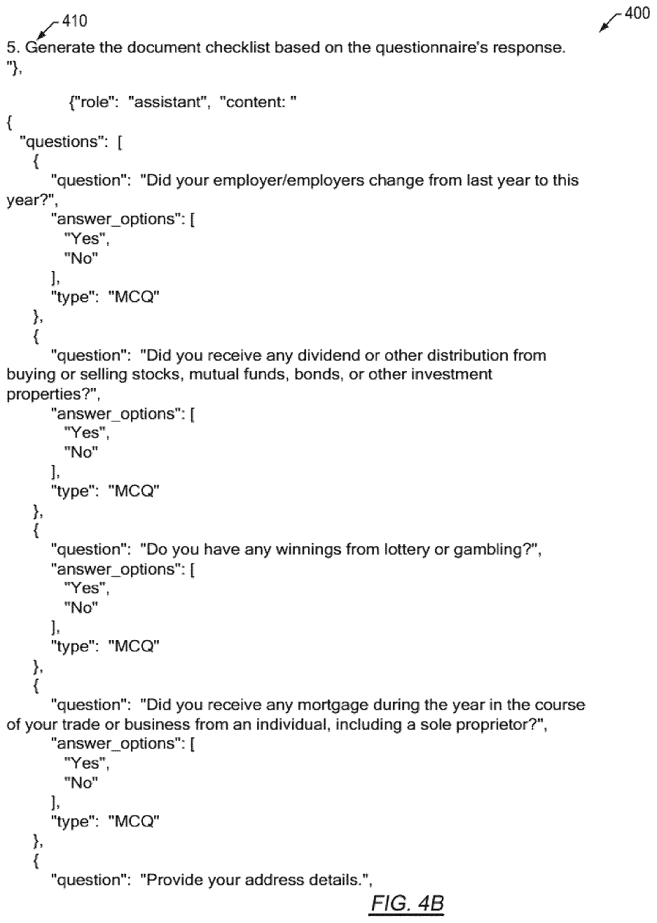

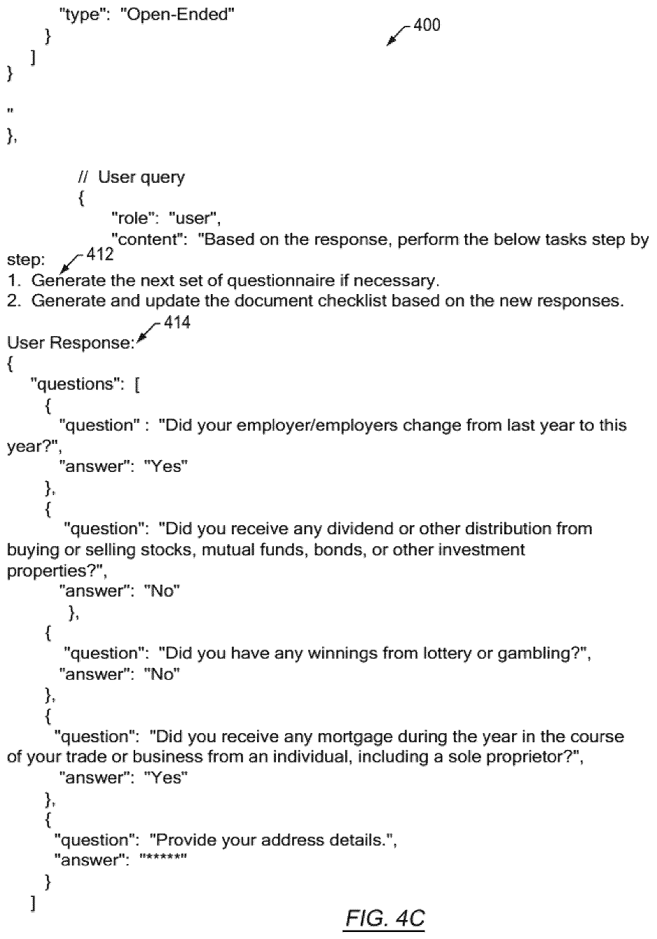

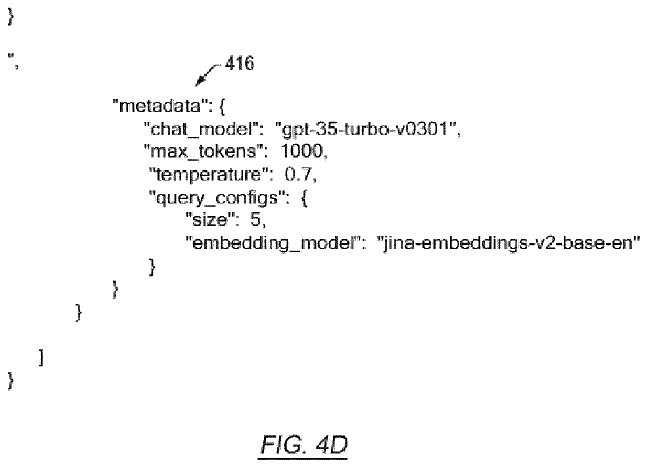

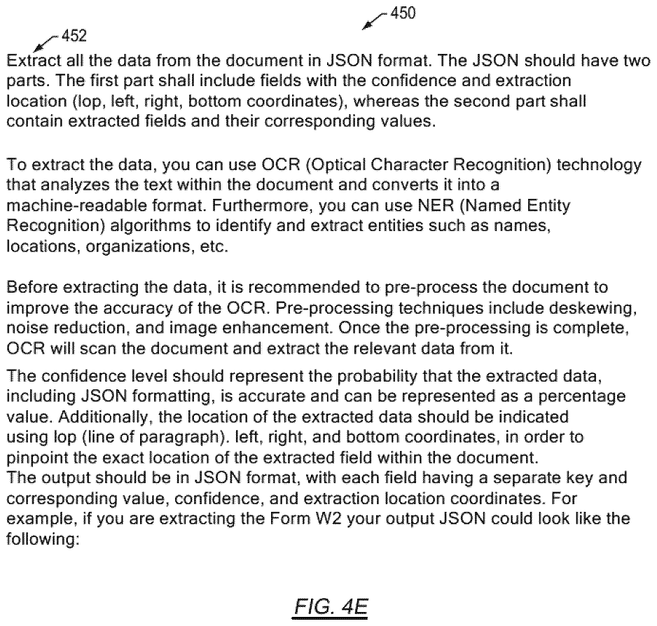

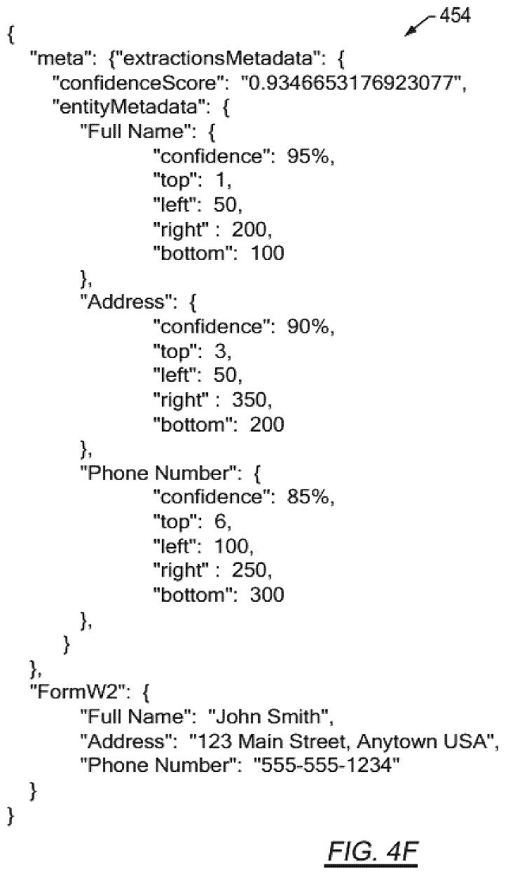

A taxpayer (i.e. an end user) sends a command via a user device to a server to prepare, automatically, the taxpayer's tax electronic forms. The server controller uses the taxpayer's identifying information, possibly together with past tax data regarding the user, as input to a first generative artificial intelligence model (“GenAI”) known as a first language model. Additionally, a first prompt is engineered (see, e.g., FIG. 4A, FIG. 4B, FIG. 4C, and FIG. 4D). The first prompt instructs the language model regarding how to generate the questions. The first language model is executed on the first prompt. The output of the first language model is one or more questions that are tailored to the specific user and are designed to elicit information from the user to determine which electronic form or forms should be prepared for the user.

The user's answers are received. The first language model may generate additional questions based on the user's answers. The additional questions are sent back to the user, and additional answers are received. The iteration of question generation and receipt of answers may continue until the language model outputs a determination that no more questions are needed, such that the desired electronic forms may be selected with a pre-determined probability of correctness.

However, the answers received may take a variety of different forms, such as images of tax documents (e.g., an image of a W-2 form, an image of a 1099 form, etc.) stored in a variety of different types of image files, text answers received from the user, past electronic form data, websites (e.g., hypertext markup language (HTML) data), etc. In the example, none of the answers are in a data structure format (i.e., a data schema) suitable for filling in the selected electronic forms.

Therefore, the answers are provided as input to a second language model. A second prompt is engineered (see, e.g., FIG. 4E and FIG. 4F). The second prompt instructs the second language model to convert the answers into a pre-determined data schema (i.e., one or more data structures, each of which stores data suitable for input to the selected electronic forms). Thus, the output of the second language model is the data schema storing the answers.

A server controller then may apply the data schema output by the second language model to the selected forms. The end result, therefore, is a series of tax forms that have been filled-in automatically server side. The tax forms may be presented to a user for validation or for submission to further processing (e.g., to submit the electronic tax forms to a governmental tax processing entity responsible for processing and receiving tax revenues and refunds).

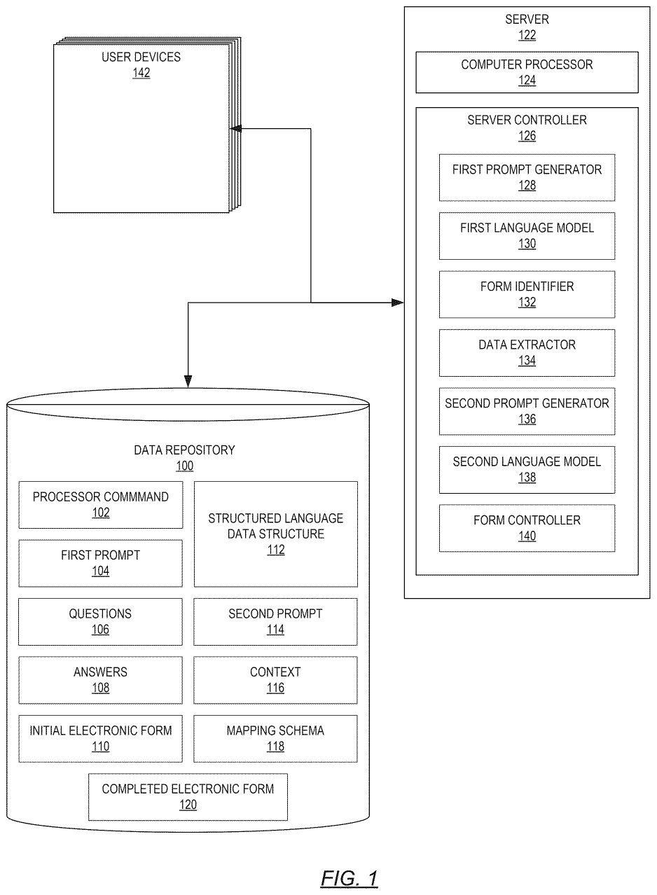

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a processor command (102). The processor command (102) is a computer readable command to the computer processor (124), defined below. The processor command (102) in one or more embodiments specifically may be a command to prepare, automatically, the completed electronic form. The processor command (102) may specify that the initial electronic form (110) (defined below) is selected from among many different electronic forms available in the data repository (100) or in some other data repository. Note that the term “initial electronic form (110)” contemplates one or more electronic forms (i.e., the term “initial electronic form (110)” should be read in both the singular and plural senses, unless explicitly stated otherwise).

The data repository (100) also stores a first prompt (104). The first prompt (104) is a natural language prompt configured, when executed upon by the first language model (130) (defined below), to generate one or more of the questions (106), defined below. An example of the first prompt (104) is shown in FIG. 4A through FIG. 4D.

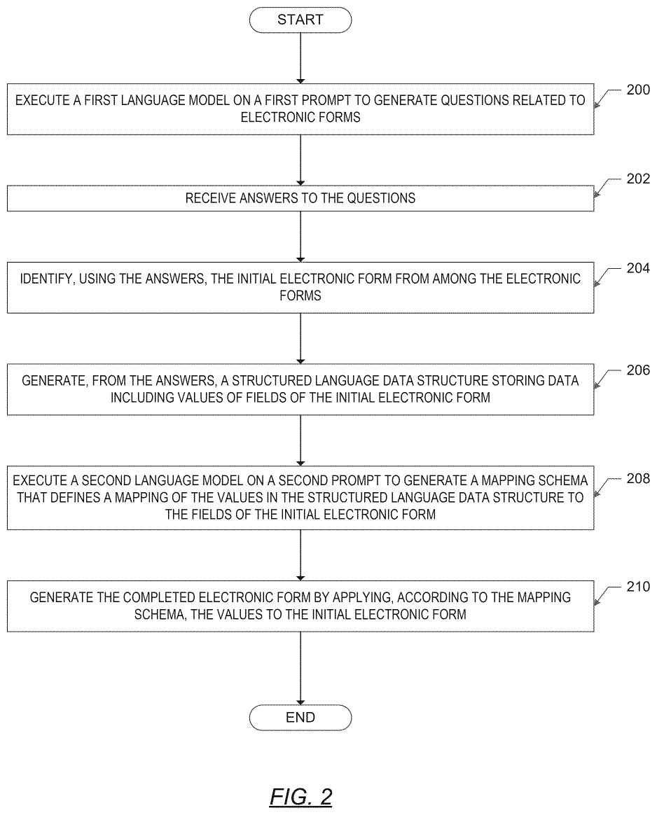

The data repository (100) also stores one or more questions (106). The questions (106) (including the possibility of a single question) are queries configured to elicit a response from one or more of the user devices (142), of the data repository (100), or of some other data storage device. Thus, the questions (106) may be natural language questions output by the first language model (130) (defined below), may be queries to another executable computer program that call the program to generate and return an output, a form that includes drop-down menus or other computer-renderable data entry widgets, images, etc. Use of the questions (106) is described further below with respect to FIG. 2.

The data repository (100) also stores one or more answers (108). The answers (108) (including the possibility of a single answer) are computer readable data structures returned in response to the questions (106). The answers (108) may be natural language text, one or more images, a filled-out form, etc. Use of the answers (108) is described with respect to FIG. 2.

The data repository (100) also stores an initial electronic form (110). The initial electronic form (110) is an electronic form, selected by the computer processor (124) from among many available electronic forms. More specifically, the initial electronic form (110) is a form that is relevant to the answers (108) provided by the user devices (142) (or some other computer process) responsive to the questions (106). The term “relevant” is defined as either an exact match or a match within a threshold degree of probability, as determined by the computer processor (124). For example, a semantic language model may determine the semantic similarity between terms in the answers (108) and the terms in the electronic forms. In this case, the “relevant” form is the form that, among the electronic forms, includes the terms that have the closest semantic match to the terms in the answers (108). Identification of the initial electronic form (110) is described further with respect to FIG. 2.

The data repository (100) also stores a structured language data structure (112). The structured language data structure (112) is a computer readable data structure that stores data in a structured language format. An example of a structured language data structure is a JAVASCRIPT® object notation language (JSON) data structure. However, other structured language data structure types exist, such as arrays, records, and nested structures. Additionally, the structured language data structure (112) also may include, in some embodiments, graph data structures, trees, or tries. In one or more embodiments, the structured language data structure (112) stores the answers (108) in a format which the server (122) may use to fill in the initial electronic form (110), thereby transforming the initial electronic form (110) into the completed electronic form (120) (defined below).

The data repository (100) also stores a second prompt (114). The second prompt (114) is a natural language prompt configured, when executed upon by the second language model (138) (defined below), to store the answers (108) in the structured language data structure (112). An example of the second prompt (114) is shown in FIG. 4E through FIG. 4F.

The data repository (100) also stores a context (116). The context (116) is one or more data files that store information of interest. More specifically, the context (116) is one or more data files that store information which the first language model (130) may reference when generating the questions (106), as described with respect to FIG. 2. When the first language model (130) operates in conjunction with the context (116), the overall process may be referred to as Retrieval Augmented Generation (RAG). Very briefly, the context (116) operates as a source data, or serves as a ground truth, that the first language model (130) references when executing on the first prompt (104). Use of the context (116) is described with respect to FIG. 2.

The data repository (100) also stores a mapping schema (118). The mapping schema (118) is a computer readable data structure or computer readable code that instructs a computer regarding the mapping of data in one computer readable data structure into another computer readable data structure of a different type. For example, the mapping schema (118) may define, or instruct a computer, regarding how data expressed as the output of an optical character recognition (OCR) format into the structured language data structure (112) defined above, into natural language text, or some other format. Thus, with respect to one or more embodiments, the mapping schema (118) instructs the server (122) regarding how to transform the answers (108) into the structured language data structure (112). Alternatively, the mapping schema (118) may be the computer program code that, when executed by the computer processor (124), transforms the answers (108) into the structured language data structure (112).

The data repository (100) also stores a completed electronic form (120). The completed electronic form (120) is the initial electronic form (110) after the mapping schema (118) has been used to transfer the answers (108) into the initial electronic form (110). The completed electronic form (120) also may be defined as an automatically generated form generated according to the method of FIG. 2.

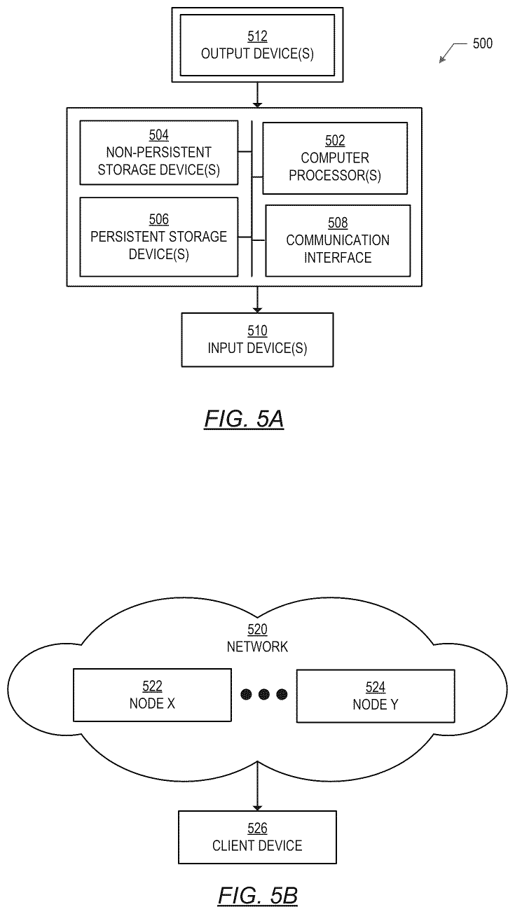

The system shown in FIG. 1 may include other components. For example, the system shown in FIG. 1 also may include a server (122). The server (122) is one or more computer processors, data repositories, communication devices, and supporting hardware and software. The server (122) may be in a distributed computing environment. The server (122) is configured to execute one or more applications, such as the server controller (126), the first prompt generator (128), the first language model (130), the form identifier (132), the data extractor (134), the second prompt generator (136), the second language model (138), and the form controller (140). An example of a computer system and network that may form the server (122) is described with respect to FIG. 5A and FIG. 5B.

The server (122) includes a computer processor (124). The computer processor (124) is one or more hardware or virtual processors which may execute computer readable program code that defines one or more applications, such as the server controller (126), the first prompt generator (128), the first language model (130), the form identifier (132), the data extractor (134), the second prompt generator (136), the second language model (138), and the form controller (140). An example of the computer processor (124) is described with respect to the computer processor(s) (502) of FIG. 5A.

The server (122) also may include a server controller (126). The server controller (126) is software or application specific hardware which, when executed by the computer processor (124), controls and coordinates operation of the software or application specific hardware described herein. Thus, the server controller (126) may control and coordinate execution of the first prompt generator (128), the first language model (130), the form identifier (132), the data extractor (134), the second prompt generator (136), the second language model (138), and the form controller (140). In an embodiment, the server controller (126) may be a collection of computer programs arranged to process inputs and outputs, as described with respect to FIG. 2, in order to generate the completed electronic form (120) from the initial information provided by a user and processed according to the processor command (102). Thus, in an embodiment, the server controller (126) may be the first prompt generator (128), the first language model (130), the form identifier (132), the data extractor (134), the second prompt generator (136), the second language model (138), and the form controller (140).

The server controller (126) therefore may include a first prompt generator (128). The first prompt generator (128) is software or application specific hardware which, when executed by the server (122), generates the first prompt (104). In an embodiment, the first prompt generator (128) may be a set of rules, may be the first language model (130) or some other language model, may be retrieved as a template selected based on user identifier or other user information, or combinations thereof. Generation of the first prompt (104) is described with respect to FIG. 2. An example of the first prompt (104) is shown in FIG. 4A, FIG. 4B, FIG. 4C, and FIG. 4D.

The server controller (126) also may include a first language model (130). The first language model (130) is a natural language processing machine learning model. A natural language processing machine learning model takes, as input, natural language and generates, as output, natural language that is responsive to the input. However, as shown in FIG. 4F, the natural language output may be structured in the form of a structured language data structure (112). An example of the first language model (130) may be a large language model, such as CHATGPT®. However, many different language models may be used. Use of the first language model (130) is described with respect to FIG. 2.

The server controller (126) also may include a form identifier (132). The form identifier (132) is software or application specific hardware which, when executed by the server (122), identifies the initial electronic form (110) from among many different available electronic forms stored in the data repository (100) or some other data storage. The form identifier (132) may be, for example, a set of rules that matches, to the various available electronic forms, information contained in the processor command (102), the answers (108), or other user information in order to identify the initial electronic form (110). The form identifier (132) also may be the first language model (130), or some other language model, which outputs the identity of the initial electronic form (110) based on the information contained in the processor command (102), the answers (108), or other user information. The form identifier (132) also may be a semantic language model that measures the semantic similarity between terms in the various electronic forms and terms used in the processor command (102), the answers (108), or other user information, and then selects the initial electronic form (110) accordingly.

The server controller (126) also may include a data extractor (134). The data extractor (134) is software or application specific hardware which, when executed by the server (122), extracts data from the answers (108). The data, as described with respect to FIG. 2, is mapped according to the mapping schema (118) into the structured language data structure (112). An example of the data extractor (134) may be the first language model (130), or some other type of machine learning model, or a set of rules that convert data from one format into another, etc.

The server controller (126) also may include a second prompt generator (136). The second prompt generator (136) is similar to the first prompt generator (128). Indeed, the second prompt generator (136) may be the same code or model that forms the first prompt generator (128). However, the second prompt generator (136) is programmed differently in order to generate the second prompt (114), which is used to command the computer processor (124) to generate the structured language data structure (112), as described with respect to FIG. 2. Thus, the second prompt generator (136) may be an entirely different program than the first prompt generator (128).

The server controller (126) may include a second language model (138). The second language model (138) is similar to the first language model (130). Indeed, the second language model (138) may be the same model as the first language model (130). However, the second language model (138) is prompted differently and thus generates a different output based on a different input. Namely, the input to the first language model (130) is the answers (108) and the output is the structured language data structure (112). Nevertheless, the second language model (138) may be an entirely different model than the first language model (130).

In an embodiment, the second language model (138) is a non-large language model. A non-large language model is a language model that is not deemed to be “large” (e.g., trained on billions of data sets used to modify billions of parameters) according to a computer scientist. For example, the second language model (138) may be a generative artificial intelligence model that may execute on text, images, etc. trained to output an application specific result. Thus, the non-large language model may have fewer parameters than a large language model. Use of a non-large language model may be deemed advantageous, because fewer computer resources are used when executing the non-large language model.

The server controller (126) also may include a form controller (140). The form controller (140) is software or application specific hardware which, when executed by the server (122), completes, manages, or manipulates an electronic form. Thus, for example, the form controller (140) may be executable by the computer processor (124) to generate, using the structured language data structure (112), the completed electronic form (120) from the initial electronic form (110).

The system shown in FIG. 1 also may include one or more user devices (142). The user devices (142) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

In any case, the user devices (142) are computing systems (e.g., the computing system (500) shown in FIG. 5A) that communicate with the server (122). Thus, the user devices (142) may receive the questions (106) from the server (122) and transmit the questions (106) to the server (122). In another embodiment, one or more of the user devices (142) may be operated by a computer technician that services the various components of the system shown in FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for an improved language model ensemble for automatically preparing electronic forms, in accordance with one or more embodiments. The method of FIG. 2 may be implemented using the system of FIG. 1 and one or more of the steps may be performed on or received at one or more computer processors. FIG. 2 may be characterized as a method for preparing a completed electronic form from an initial electronic form that is initially unknown and using form data that initially is unavailable.

Step 200 includes executing a first language model on a first prompt to generate questions related to electronic forms. Executing the first language model may be performed by generating, using a user identification transmitted with the processor command, the first prompt. The first prompt commands the first language model, when executed by the computer processor, to generate the questions. Thus, executing the first language model on the first prompt generates the questions.

The first prompt may be generated by executing a first prompt generator on the information received from a processor command to fill in a completed electronic form, when the electronic form and the data used to fill in the electronic form initially are unknown. For example, the processor command may include a user identification, information about the user, etc. The first prompt generator also may access a user profile based on the user's identity. The first prompt generator also may access past historical data or past historical electronic forms completed by the user. The first prompt generator takes, as input, the information described above and generates, as output, the questions.

In any case, the server transmits the questions to a user device. Thereafter, the server receives the answers to the questions from the user device. In another embodiment, the questions may be transferred to some other computer process (e.g., a large language model) which processes the questions and returns the answers.

Step 200 may be preceded by receiving a processor command to prepare, automatically, the completed electronic form. The command may be received from the user device, or from some other automated process. The processor command specifies that the initial electronic form is selected from the available electronic forms.

Step 202 includes receiving answers to the questions. The answers may be received from a user device. For example, the user may answer the questions in natural language text, via widgets on a form, supplying images of documents, etc. The answers are transmitted to the server.

Step 202 may be an iterative process in some embodiments. For example, step 202 also may include generating, in response to receiving the answers, an updated prompt. The updated prompt commands the first language model to generate additional questions based on the answers. Then, the first language model is executed on the updated prompt to generate an updated question. The updated question is transmitted to a user device. An updated answer to the updated question is received. In this embodiment, identifying the initial electronic form is further performed using the updated answer. Thus, multiple answers may be generated and received in an iterative process between steps 200 and 202.

Step 204 includes identifying, using the answers, the initial electronic form from among the electronic forms. Identifying the answers may be performed by comparing the answers to a set of rules. The answers are input to the rules, and the output of the rules is one or more electronic forms that are treated as the initial electronic form.

Identifying the initial electronic form also may be performed by other techniques. For example, step 204 may be performed by inputting the answers, a user identifier to the first language model, a prompt (e.g., selected from a prompt template), or combinations thereof to a language model. The language model is executed on the input and generates, as output, an identification of the initial electronic form. The output of the language model is the identification of the initial electronic form at step 204.

Step 206 includes generating, from the answers, a structured language data structure storing data including values of fields of the initial electronic form. The structured language data structure may be generated by a variety of different techniques, depending on the nature of the data contained in the answers. For example, text may be parsed into key-value pairs and the key-value pairs stored in the structured language data structure.

In another example, generating the structured language data structure may be performed by extracting field identifiers from the initial electronic form. For example, an optical character recognition program or a language model (e.g., the second language model) may extract text from an image. Then, a data extractor may extract, from the answers, values for the field identifiers. For example, values associated with the text may be extracted and stored as values. The data extractor then converts the field identifiers and the values to the structured language data structure. In any case, the data extractor stores the structured language data structure.

In still another example, generating the structured language data structure may be performed by the data extractor generating, using the answers, a third prompt for the second language model. The third prompt includes a fourth section and a fifth section. The fourth section of the third prompt commands the second language model to extract data from the answers for fields of the initial electronic form. The fifth section of the third prompt commands the second language model to format the answers into a structured language data structure. Thus, the output of the language model in this example is the structured language data structure. An example of such a prompt is shown in FIG. 4E and FIG. 4F.

Step 208 includes executing a second language model on a second prompt to generate a mapping schema that defines a mapping of the values in the structured language data structure to the fields of the initial electronic form. The mapping schema may be generated by commanding the second language model to apply the key-value pairs in the structured language data structure to the fields of the initial electronic form. In other words, the input to the second language model is the second prompt, the structured language data structure, and the initial electronic form. The output of the second language model is a specification that indicates which keys and which values in the structured language data structure should be inserted into the corresponding fields and entries of the initial electronic form.

In another example, step 208 may include a second prompt generator retrieving a prompt template. The second prompt generator then adds, to a first section of the prompt template, a command to reference a context including data formatting rules and data mapping rules. The second prompt generator then adds, to a second section of the prompt template, a processor command to generate the mapping schema from the structured language data structure and the initial electronic form. In this example, the second prompt is then the mapping schema.

Step 210 includes generating the completed electronic form by applying, according to the mapping schema, the values to the initial electronic form. The application of the values to the initial electronic form according to the mapping schema may be performed by one or more rules. For example, a form controller may include matching a first key in the structured language data structure to a second key in the initial electronic form. The form controller then fills in a second value for the second key in the initial electronic form according to a first value for the first key in the structured language data structure.

In another example, referencing one of the examples of step 208, the mapping schema may be applied by executing the second language model on the second prompt. The language model then automatically fills out the electronic form according to the instructions provided in the second prompt.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

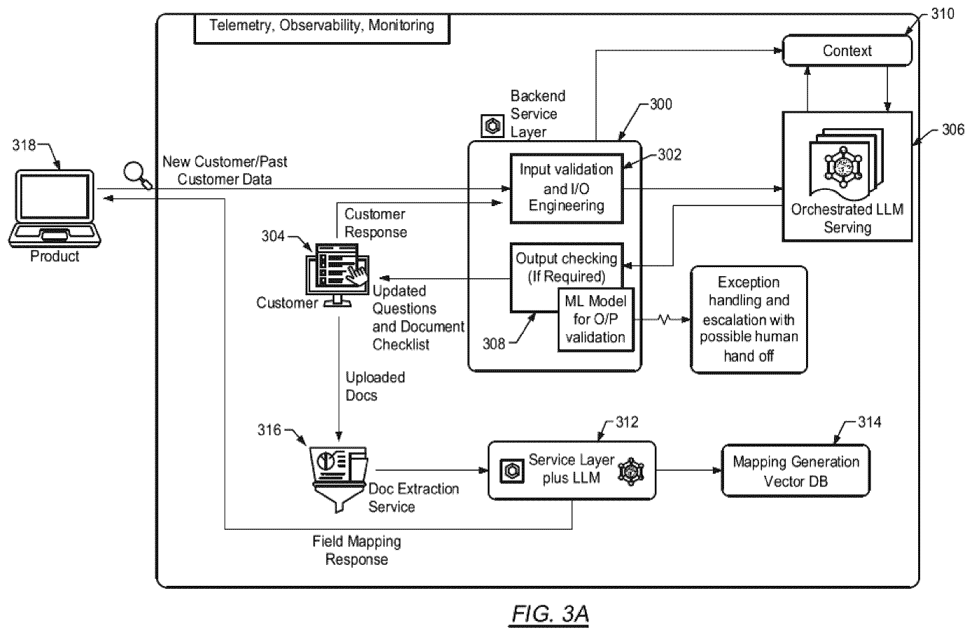

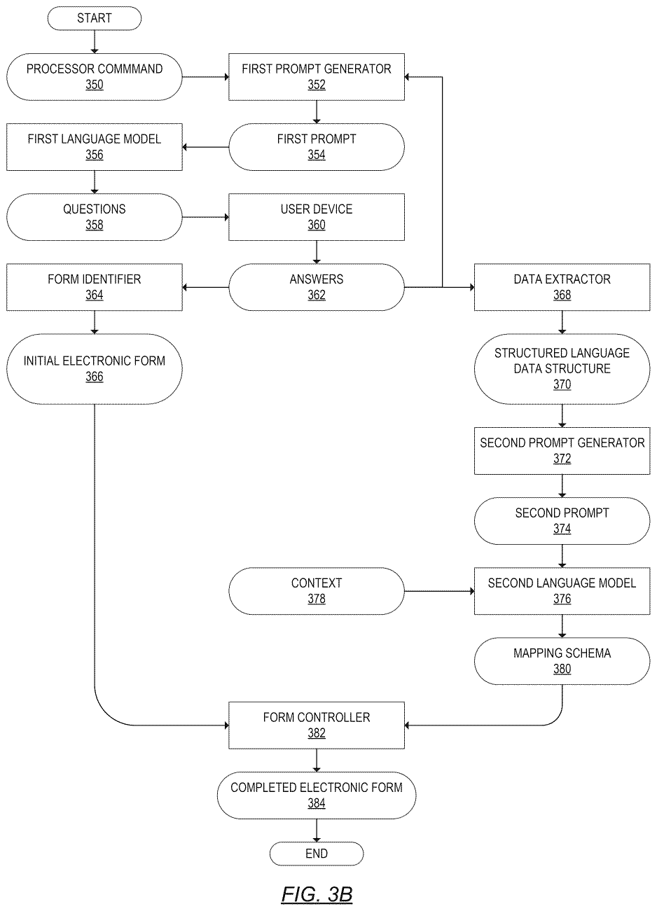

FIG. 3A shows an architecture of a computing system for an improved language model ensemble for automatically preparing electronic forms, in accordance with one or more embodiments. The architecture includes a backend service layer (300). The backend service layer (300) includes an input validation and output engine (302) that coordinates the input from a customer (304) and output to an orchestrated language model (306). The backend service layer (300) also includes an output checking engine (308) that checks the output (i.e., the filled-in electronic form) from the orchestrated language model (306) before delivering the output to the customer (304).

The orchestrated language model (306) may be the language model ensemble, as described above. In other words, the orchestrated language model (306) may include both the first language model and the second language model, as described above, together with possibly other language models. However, in another embodiment, the orchestrated language model (306) may include only the first language model. The orchestrated language model (306) may reference a context (310) as part of a retrieval augmented generation (RAG) system, as described above, as part of generating the questions. The context (310) may store questionnaire rules, for example, in the form of vectors that are readable by the language models in the orchestrated language model (306). Thus, the first large language model references the rules when determining which questions to present to the customer (304).

In another embodiment, the second language model may be present in a second service layer (312). In an embodiment, the second service layer (312) may reference a mapping generation context (314) that stores rules for mapping data from the extracted data from the answers supplied by the customer (304). The mapping generation context (314) also may include prompt templates for generating the second prompt described above.

The architecture shown in FIG. 3 also may include a document extraction service (316). The document extraction service (316) may be the data extractor (134) described with respect to FIG. 1. The document extraction service (316) therefore may extract data from the answers that the customer (304) provides in response to the questions generated by the orchestrated language model (306).

The architecture shown in FIG. 3 also may reference other types of data. For example, the architecture may reference a data storage (318). The data storage (318) may store information about the customer (304), separate from the answers supplied by the customer (304). For example, the data storage (318) also may store past electronic forms prepared for the user, user information, user profiles, etc., for use as described above with respect to FIG. 1 and FIG. 2.

FIG. 3B shows a data flow for an improved language model ensemble for automatically preparing electronic forms, in accordance with one or more embodiments. The data flow shown in FIG. 3B may be a data flow that accomplishes the method of FIG. 2, but also includes the processes that perform the various steps. Thus, the data flow of FIG. 3B may be considered a specific exemplary variation of the method of FIG. 2.

Initially, a processor command (350) is received and input to a first prompt generator (352). The first prompt generator (352) outputs a first prompt (354). The first prompt (354) is then provided to a first language model (356). The first language model (356) generates, as output, one or more questions (358).

The questions (358) are transmitted to a user device (360). The user device (360) returns one or more answers (362) to the questions (358). In an embodiment, the answers (362) may be returned back to the first prompt generator (352). In this case, another instance of the first prompt (354) is generated, including the answers. The process then may repeat in an iterative process until the first language model (356) determines that no more relevant questions should be presented to the user device (360).

The answers (362) are provided to a form identifier (364). The form identifier (364), using the answers (362), determines an initial electronic form (366) to be used in preparing the form identifier (364) (described below). The initial electronic form (366) is then provided to a form controller (382) for further processing, as described below.

Returning back to the answers (362), the answers (362) are also provided to a data extractor (368). The data extractor (368) extracts the data from the answers (362) and converts the data into a structured language data structure (370).

In turn, the structured language data structure (370) is provided as input to a second prompt generator (372). The second prompt generator (372) uses the structured language data structure (370) to generate a second prompt generator (372). The second prompt generator (372) also may use a context, rules, or a combination thereof to generate a second prompt (374).

The second prompt (374) is then provided as input to a second language model (376). The second language model (376) may reference a context (378) to ensure that the second language model (376) applies the correct rules to the second prompt (374) when converting the information in the structured language data structure (370) into a mapping schema (380). The output of the second language model (376) is the mapping schema (380).

The mapping schema (380) is provided as input to the form controller (382), together with the initial electronic form (366) from earlier in the data flow of FIG. 3B. The form controller (382) applies the mapping schema (380) to the initial electronic form (366) and generates, as output, the completed electronic form (384).

The completed electronic form (384) then is returned. For example, the completed electronic form (384) may be transmitted back to a user for validation. The completed electronic form (384) also may be used in additional processing. For example, if the completed electronic form (384) is a tax document, the completed electronic form (384) may be provided to tax preparation software for the determination and preparation of the user's tax return.

FIG. 4A, FIG. 4B, FIG. 4C, and FIG. 4D show an example of a first prompt for a first language model to generate a number of questions related to a number of electronic forms, in accordance with one or more embodiments. The prompt (400) includes a system prompt (402) which provides general instructions to the large language model when determining questions to present to the user.

The prompt (400) also includes a chat history (404) which references past historical information available for the user in question. The user need not provide the information in the chat history (404), as the information in the chat history (404) is already available to the system. The chat history (404) may be retrieved based on the user identity specified by the user identifier (406).

The prompt (400) also may include explicit instructions (408). The instructions (408) instructs the language model how to generate the desired questions, and the order in which to perform the instructions for generating the desired questions.

Turning to FIG. 4B, the prompt (400) also may include a command (410) that defines the data structure in which the language model returns an output. Thus, when the language model generates the questions, the questions will be in the format defined in the command (410). For example, a question in quotation marks may be presented to the user, along with prompts directing the user regarding the type of answer that is considered acceptable to the question.

Turning to FIG. 4C, the prompt (400) also may include instructions for generating additional questions based on the user's answers. Thus, an additional set of instructions (412) is provided to the language model for generating additional questions based on the answers provided by the user. An additional command (414) (which also may include the additional set of instructions (412)) is provided that instructs the language model regarding the structure and nature of additional questions, or examples of additional questions, that may be presented to the user. Finally, FIG. 4D may provide final commands (416) that impose limits on the language model when generating the first questions.

FIG. 4D, FIG. 4E, and FIG. 4F shows an example of a second prompt (450) for a second language model to generate a mapping schema that defines a mapping of the values in the structured language data structure to the fields of the initial electronic form, in accordance with one or more embodiments. In particular, FIG. 4E shows general instructions (452) that instruct the second language model regarding the nature of the mapping schema and rules for generating the mapping schema, as shown.

FIG. 4F then shows formatting instructions (454) which instruct the second language model how to structure and generate the mapping schema. In the examples shown, the formatting instructions provide the names of keys and the coordinates in the initial electronic form where the values in the answers should be placed for the corresponding keys.

Ultimately, the mapping schema is output by the second language model after executing on the second prompt (450). The mapping schema then may be applied to the answers so that the keys in the answers may be transferred to the correct locations in the initial electronic form. As a result, a completed electronic form is generated, which may be returned to a user, transmitted to another software program for additional processing, or a combination thereof.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method for preparing a completed electronic form from an initial electronic form that is initially unknown and using form data that initially is unavailable, the method comprising:
executing a first language model on a first prompt to generate a plurality of questions related to a plurality of electronic forms;
receiving a plurality of answers to the plurality of questions;
identifying, using the plurality of answers, the initial electronic form from among the plurality of electronic forms;
generating, from the plurality of answers, a structured language data structure storing data comprising values of fields of the initial electronic form;
executing a second language model on a second prompt to generate a mapping schema that defines a mapping of the values in the structured language data structure to the fields of the initial electronic form; and
generating the completed electronic form by applying, according to the mapping schema, the values to the initial electronic form.

2. The method of claim 1, further comprising:
receiving a processor command to prepare, automatically, the completed electronic form, wherein the processor command specifies that the initial electronic form is selected from the plurality of electronic forms.

3. The method of claim 2, further comprising:
generating, using a user identification transmitted with the processor command, the first prompt, wherein the first prompt commands the first language model to generate the plurality of questions.

4. The method of claim 3, further comprising:
executing the first language model on the first prompt to generate the plurality of questions.

5. The method of claim 4, further comprising:
generating, in response to receiving the plurality of answers, an updated prompt, wherein the updated prompt commands the first language model to generate additional questions based on the plurality of answers;
executing the first language model on the updated prompt to generate an updated question;
transmitting the updated question to a user device; and
receiving an updated answer to the updated question, wherein identifying the initial electronic form is further performed using the updated answer.

6. The method of claim 1, further comprising:
transmitting the plurality of questions to a user device, wherein receiving the plurality of answers comprises receiving the plurality of answers from the user device.

7. The method of claim 1, wherein identifying the initial electronic form comprises comparing the plurality of answers to a set of rules.

8. The method of claim 1, wherein identifying the initial electronic form comprises inputting the plurality of answers and a user identifier to the first language model and receiving, as an output of the first language model, an identification of the initial electronic form.

9. The method of claim 1, wherein generating the structured language data structure comprises:
extracting a plurality of field identifiers from the initial electronic form;
extracting, from the plurality of answers, a plurality of values for the plurality of field identifiers;
converting the field identifiers and the plurality of values to the structured language data structure; and
storing the structured language data structure.

10. The method of claim 1, wherein generating the structured language data structure comprises:
generating, using the plurality of answers, a third prompt for the second language model, wherein the third prompt comprises a fourth section and a fifth section, and further wherein:
the fourth section of the third prompt commands the second language model to extract data from the plurality of answers for a plurality of fields of the initial electronic form, and
the fifth section of the third prompt commands the second language model to format the plurality of answers into an structured language data structure.

11. The method of claim 1, further comprising:
generating the second prompt.

12. The method of claim 11, wherein generating the second prompt comprises:
retrieving a prompt template;
adding, to a first section of the prompt template, a command to reference a context comprising data formatting rules and data mapping rules; and
adding, to a second section of the prompt template, a processor command to generate the mapping schema from the structured language data structure and the initial electronic form.

13. The method of claim 1, wherein generating the completed electronic form is performed by:
matching a first key in the structured language data structure to a second key in the initial electronic form, and
filling in a second value for the second key in the initial electronic form according to a first value for the first key in the structured language data structure.

14. The method of claim 1, wherein the first language model is different than the second language model.

15. The method of claim 14, wherein the first language model comprises a large language model, and wherein the second language model comprises a non-large language model.

16. A system comprising:
a computer processor;
a data repository in communication with the computer processor and storing:
a processor command to prepare, automatically, a completed electronic form for a user having a user identification,
an initial electronic form selected from among a plurality of electronic forms,
a plurality of questions related to the plurality of electronic forms,
a plurality of answers corresponding to the plurality of questions,
a first prompt, wherein the first prompt commands a first language model to generate the plurality of questions,
a structured language data structure,
a context,
a mapping schema that defines a mapping of values in the structured language data structure to fields of the initial electronic form,
a second prompt for a second language model, wherein
the second prompt comprises a first section and a second section,
the first section commands the second language model to reference the context comprising data formatting rules and data mapping rules,
the second section commands the second language model to generate the mapping schema; and
the completed electronic form, wherein the completed electronic form is based on the initial electronic form; and
a server controller which, when executed by the computer processor, performs a computer-implemented method comprising:
receiving the processor command, wherein the initial electronic form is initially unknown and form data for the completed electronic form initially is unavailable,
generating, using the user identification, the first prompt,
executing the first language model on the first prompt to generate the plurality of questions,
transmitting the plurality of questions to the user and receiving the plurality of answers from the user,
identifying, using the plurality of answers, the initial electronic form from among the plurality of electronic forms,
generating, from the plurality of answers, the structured language data structure,
generating the second prompt,
executing the second language model on the second prompt to generate the mapping schema; and
generating the completed electronic form by applying, according to the mapping schema, the values to the initial electronic form.

17. The system of claim 16, wherein the server controller further comprises:
a first prompt generator executable by the computer processor to generate the first prompt; and
a second prompt generator executable by the computer processor to generate the second prompt.

18. The system of claim 16, wherein the server controller further comprises:
the first language model, wherein the first language model comprises a large language model; and
the second language model, wherein the second language model comprises a non-large language model.

19. The system of claim 16, wherein the server controller further comprises:
a form identifier executable by the computer processor to identify the initial electronic form from the plurality of electronic forms;
a data extractor executable by the computer processor to extract the structured language data structure from the plurality of answers; and
a form controller executable by the computer processor to generate, using the structured language data structure, the completed electronic form from the initial electronic form.

20. A method comprising:
receiving a processor command to prepare, automatically, a completed electronic form for a user having a user identification, wherein:
the completed electronic form is based on an initial electronic form selected from a plurality of electronic forms,
the initial electronic form initially is unknown, and
form data for the completed electronic form initially is unavailable;
generating, using the user identification, a first prompt for a first language model, wherein the first prompt commands the first language model to generate a plurality of questions related to the plurality of electronic forms;
executing the first language model on the first prompt to generate the plurality of questions;
transmitting the plurality of questions to the user and receiving, from the users, a plurality of answers corresponding to the plurality of questions;
identifying, using the plurality of answers, the initial electronic form from among the plurality of electronic forms;
generating, from the plurality of answers, a structured language data structure storing data comprising values of fields of the initial electronic form;
generating a second prompt for a second language model, wherein:
the second prompt comprises a first section and a second section,
the first section commands the second language model to reference a context comprising data formatting rules and data mapping rules, and
the second section commands the second language model to generate a mapping schema that defines a mapping of the values in the structured language data structure to the fields of the initial electronic form; and
executing the second language model on the second prompt to generate the mapping schema; and
generating the completed electronic form by applying, according to the mapping schema, the values to the initial electronic form.
